(19) United States
(12) Patent Application Publication
(10) Pub. No.: US 2010/0306198 A1
(43) Pub. Date: Dec. 2, 2010

(54) SYSTEM AND METHOD FOR DETERMINING CATEGORIES ASSOCIATED WITH SEARCHES OF ELECTRONIC CATALOGS AND DISPLAYING CATEGORY INFORMATION WITH SEARCH RESULTS

(75) Inventor: Nicholas GADACZ, San Francisco, CA (US)

Correspondence Address: Reed Smith LLP, P.O. Box 488, Pittsburgh, PA, 15230, US

(73) Assignee: CBS INTERACTIVE, INC., County of New Castle, DE (US)

(21) Appl. No.: 12/476,398

(22) Filed: Jun. 2, 2009

(51) Int. Cl. G06F 17/30

(52) U.S. Cl. 707/738; 705/26; 707/769; 707/759; 707/770

(57) ABSTRACT

Various embodiments are presented which comprise an electronic catalog of products, wherein the user searches the catalog and the embodiments identify what categories of products in the catalog are referred to by the user's search query. These categories are then displayed onscreen with the results of the user's search, and may present controls that control the user's search results.

### CROSS-REFERENCE TO RELATED APPLICATIONS

The present invention is not related to any co-pending applications.

### FIELD OF THE INVENTION

The present invention relates to a system and method for isolating category information from a query performed by a search engine that searches a catalog and displaying information about the category separately and simultaneously from the results of the search.

### DESCRIPTION OF THE RELATED ART

Many websites are configured as online catalogs. These catalogs act as alternatives to traditional paper catalogs and offer enhanced navigational features when compared to their paper counterparts, as well as the advantages of broad, easy distribution. With the advent and increasing popularity of the Internet, suppliers have access to a much larger customer base. Through the Internet, the market base of manufacturers and resellers may be maximized while the associated overhead may potentially be drastically reduced. If an electronic catalog is well-organized and presented, it can help consumers to make good purchasing decisions by providing extensive information about the products they contain in an easy-to-navigate manner. Such a catalog either allows the consumers to gain information about products they will purchase elsewhere or to make purchases within the site itself Additionally, such a catalog serves as a site where companies may purchase advertising to market their products.

Such electronic catalogs generally store, in a database, information about a number of products which may be anything from electronics to housewares to apparel, or any other type of item which may be depicted and/or described electronically. Such items may be described by a taxonomy, which describes the set of products with a set of information that consists of a set of attributes that assume values. That is, each product might be associated with a price, brand, or other attribute. Some attributes would only be stored for some classes of product. For example, weight might be a attribute with respect to laptops, but not desktop computers, while both might have a processor speed attribute.

When accessing the information in a catalog, one method which may be used is to use a search engine. Search engines receive queries from the user, which are generally a string which specifies the terms in which the user are interested, although there are other ways of specifying a query. The key element of a query is that it must specify to the search engine through some means, whether it be a simple text string, filling out a form, or constructing some sort of the model of the given data, information about the desired qualities of the information which the user wants to retrieve.

Such a search engine may consist of an integrated search engine faculty built into the catalog or a commercial search engine such as Google™ or Yahoo™ which identifies the catalog as a relevant “hit”, or search result on the Web which corresponds with the user's preferences.

It is, of course, known in the art to provide the user with a list of products that meet the requirements of the query.

### SUMMARY OF THE INVENTION

The invention uses derived from the query to provide information about the taxonomic classification that the query is directed towards.

These embodiments of the invention enhance the user's interface when they access a product catalog as described above using a search engine by identifying, from the search engine's query, category information, which indicates what part or parts of the taxonomy the user is searching for at the top level(s) of the taxonomy. The embodiments then provide two simultaneous views, one of which displays information about the category and one of which displays information about products which satisfy the query.

This approach enhances the user interface with the catalog and thereby provides several unexpected advantages. First, the user is simultaneously provided with enhanced category information as well as a list of products. This category information is obtained from the search query, using a technique which has not been used heretofore. The category information may provide information about the category such as trends, distributions, or patterns that may aid in buying decision. Second, the category display may be arranged to facilitate access and navigation to the list by having links or other controls that facilitate navigation through the catalog. A third advantage is that because the information is displayed simultaneously, it allows the user to compare the information from the category pane with the list of products in an easy-to-use manner and easily have information and commands flow between the parts of the display.

According to one embodiment of the invention, there is provided: A computer system designed to use category information from searches to facilitate access to a catalog, comprising: a database module configured to store an electronic catalog of products, wherein the catalog comprises a taxonomy of products categories and products within the categories, the catalog further comprising attributes which describe products in a category and at least one value for said attributes, a user interface module configured to display, using a display device, information about the contents of the catalog, in response to input by the user, a search engine module configured to accept a query from a user, wherein at least part of said query corresponds with at least one of the categories, query the catalog, and present a subset of products in the catalog corresponding to the user's query to said user interface module for display to said at least one user. A query association module; configured to monitor the ongoing stream of queries, and analyze the contents of each query to identify if part or all of a query corresponds with a category, and when part or all of said query corresponds with a category. The user interface module provides the user with access to the catalog via the user interface module in a manner that includes simultaneous and segregated display of information about the category and information about products which satisfy the query.

According to one embodiment of the invention, there is provided: A computer-implemented method designed to use category information from searches to facilitate access to a catalog, comprising: operating, using a processor, a database module configured to store an electronic catalog of products, wherein the catalog comprises a taxonomy of products categories and products within the categories, the catalog further comprising attributes which describe products in a category and at least one value for said attributes, operating, using a processor, a user interface module configured to display, using a display device, information about the contents of the catalog, in response to input by the user operating, using a processor, a search engine module configured to accept a query from a user, wherein at least part of said query corresponds with at least one of the categories, query the catalog, and present a subset of products in the catalog corresponding to the user's query to said user interface module for display to said at least one user, operating, using a processor, a query association module configured to monitor the ongoing stream of queries, and analyze the contents of each query to identify if part or all of a query corresponds with a category, and when part or all of said query corresponds with a category, said user interface module provides the user with access to the catalog via the user interface module in a manner that includes simultaneous and segregated display of information about the category and information about products which satisfy the query.

According to one embodiment of the invention, there is provided: An apparatus designed to use category information from searches to facilitate access to a catalog, comprising: means for operating, using a processor, a database module configured to store an electronic catalog of products, wherein the catalog comprises a taxonomy of products categories and products within the categories, the catalog further comprising attributes which describe products in a category and at least one value for said attributes, means for operating, using a processor, a user interface module configured to display, using a display device, information about the contents of the catalog, in response to input by the user, means for operating, using a processor, a search engine module configured to accept a query from a user, wherein at least part of said query corresponds with at least one of the categories, query the catalog, and present a subset of products in the catalog corresponding to the user's query to said user interface module for display to said at least one user, means for operating, using a processor, a query association module configured to monitor the ongoing stream of queries, and analyze the contents of each query to identify if part or all of a query corresponds with a category, and when part or all of said query corresponds with a category, said user interface module provides the user with access to the catalog via the user interface module in a manner that includes simultaneous and segregated display of information about the category and information about products which satisfy the query.

According to one embodiment of the invention, there is provided: Computer readable media, having instructions stored thereon, wherein the instructions, when executed by a processor, perform computing functions designed to use category information from searches to facilitate access to a catalog stored on a computer, comprising: instructions for operating, using a processor, a database module configured to store an electronic catalog of products, wherein the catalog comprises a taxonomy of products categories and products within the categories, the catalog further comprising attributes which describe products in a category and at least one value for said attributes, instructions for operating, using a processor, a user interface module configured to display, using a display device, information about the contents of the catalog, in response to input by the user, instructions for operating, using a processor, a search engine module configured to accept a query from a user, wherein at least part of said query corresponds with at least one of the categories, query the catalog, and present a subset of products in the catalog corresponding to the user's query to said user interface module for display to said at least one user, instructions for operating, using a processor, a query association module configured to monitor the ongoing stream of queries, and analyze the contents of each query to identify if part or all of a query corresponds with a category, and when part or all of said query corresponds with a category, said user interface module provides the user with access to the catalog via the user interface module in a manner that includes simultaneous and segregated display of information about the category and information about products which satisfy the query.

### BRIEF DESCRIPTION OF THE DRAWINGS

FIG. 1 is a diagram illustrating the interactions between the components of a system embodiment of the present invention.

FIG. 2 is a diagram illustrating a taxonomy in accordance with system in which the present invention may be implemented.

FIG. 3 is an illustration of a sample display of category information about cell phones displayed along with product search results for the query.

FIG. 4 is a diagram illustrating sample queries and illustrating how they are processed to yield category information.

FIG. 5 is a flowchart illustrating the method according to one embodiment of the invention.

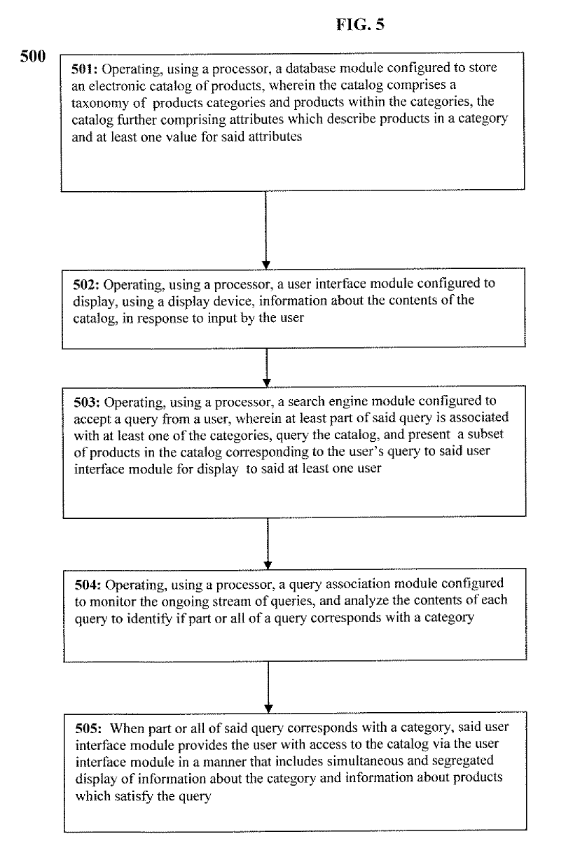

FIG. 6 is a screenshot of a webpage which is the homepage of an electronic catalog in conformance with the requirements of an embodiment of the invention.

### DETAILED DESCRIPTION OF THE INVENTION

In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

Embodiments are described herein that involve catalog data to which is stored and organized in an efficient manner through the use of a taxonomy. The taxonomy categorizes the products by using attributes, where products are associated with one or more values of the attributes. Such attributes describe and organize the products in the catalog for retrieval. However, the taxonomy as a whole is divided into one or more levels of categories, with which the attributes are associated.

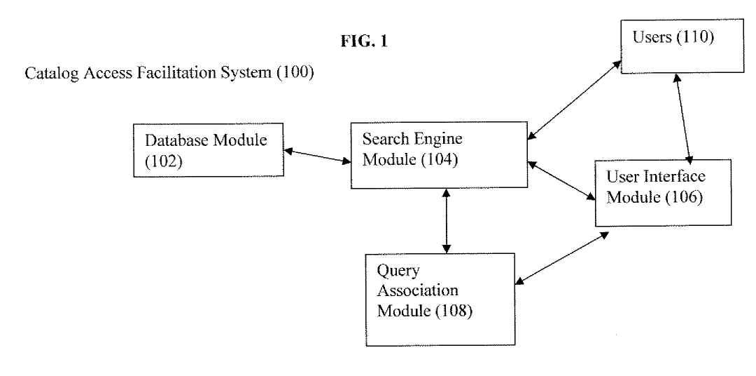

The configuration of the catalog access facilitation system 100 is characterized in FIG. 1. The catalog is ideally stored in a database module 102. The database may preferably employ a relational model, though it may alternatively employ a flat model, hierarchical model, network model, dimensional model, object model, object-relational model or any combination of the above or other database formats. The database may use a querying language such as SQL to retrieve data internally. Alternatively, the catalog may be stored in another file or collection of files such as a word processing document, or spreadsheet. The catalog information may be stored on a single machine or on multiple machines over a network. Ideally the catalog is accessible over the Web though a web browser or over another network, but embodiments exist where the catalog is accessible directly from a dedicated program where the catalog is stored locally. The contents of the catalog may be stored upon any tangible medium, such as, but not limited to: magnetic media, optical media, magneto-optical media, solid-state memory, and/or flash memory. The catalog may be stored locally or distributed over a network.

The database module 102 receives requests to access the contents of the catalog under the control of a computer processor, which mediates requests which are required by the user interface module 106, which may preferably be a monitor with input devices such as a keyboard and mouse providing a Web page, or other GUI interface, but may also involve alternative forms of interaction such as a command line, audio input/output or printed output, or assorted I/O peripherals such as a joystick, gamepad, trackpad, trackball, or other forms of I/O such as those used by the disabled, in order to interact with the user 110 who enters a query into a search engine module 104. The search engine module derives results from the database module 102, but alto the query association module 108 processes the query so that the user interface module 106 receives information from the search engine module 104 and query association module 108, and displays it to the user 110. At this point the user 110 can interact with the information provided by the embodiments.

Within the catalog, the taxonomy allows the products to be divided into categories, each of which has subcategories with their own particular set of subcategories. This categorization exists based on the structure of the attributes that are each associated with a given category of product. As an example, in one embodiment, the products could be computers, which are divided into subcategories of laptops and desktops. The laptops can be further subdivided into subcategories, which might include “netbook”, “thin-and-light”, “mainstream”, and “desktop replacement”. Attributes in these subcategories can be weight, price (which might be divided by ranges), and type of processor. On the other hand the desktops might also be have the attributes of price and type of processor, but might have other attributes associated with them, like “form factor” and “number of drive bays”. Moreover, certain attributes might have multi-leveled answers. For example, a processor might be have a processor brand of Intel™, which would then lead to an attribute to differentiate that it was a “Core 2™”, then “Core 2 Duo™” as opposed to “Core 2 Quad™”. Some attributes which are of particular use if the catalog refers to technological products would attributes which specify the brand, price, and various aspects of the technology involved in the product, such as particular technological features, such as speed, capacity, or special capabilities inherent to a device.

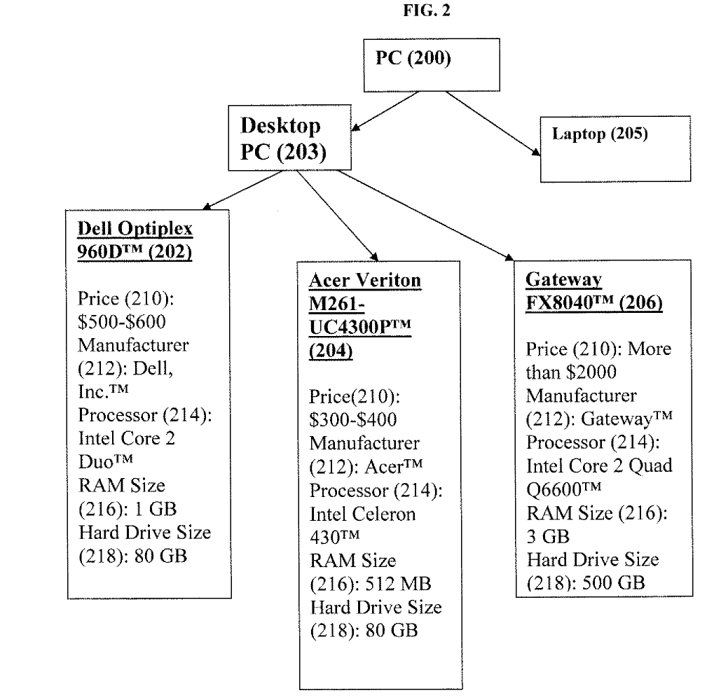

An example taxonomy is presented in FIG. 2, for Desktop PCs. The category of PCs 200 branches into the subcategories of Desktop PCs 203 and Laptop PCs 205. Desktop PCs 203 contain 3 examples of Desktop PCs, Dell Optiplex 960D™ (202) Acer Veriton M261-UC4300P™ (204), and the Gateway FX8040™ (206). Each of these has a value for attributes such as price 210, manufacturer 212, processor 214, RAM size 216, and hard drive size 218. Clearly, the implementation of such a taxonomy will differ by the database model or alternative schema used to store the database in the database module 102. However, given a relational model, such a taxonomy can be stored in one embodiment by associating the products with unique product IDs, then creating tables that associate the IDs with attributes, then creating tables that associate the IDs within the attributes with various values within the taxonomy, in a manner well known in the art to associate pieces of data with information that describes them through relational tables. However, many alternative embodiments are possible and this merely represents a preferred method of storing the catalog if the RDBMS approach is chosen.

It is to be noted that the catalog need not represent a set of tangible products represented by nodes within the taxonomy. The catalog may also operate on a digital level, and contain items of digital content. These items may contain digital text, audio, MIDI data, recorded audiobooks, digital music, bitmapped and/or vector graphics, digital photographs, video, movies, TV episodes, digital documents, animations, software, web content, multimedia, any form of encoded or archived data, and/or any other type of file or group of files which may be use to store useful computer data. These files may be stored locally or remotely from the web site or other interface shell which is used to allow the user to access the catalog.

Ideally, a catalog which is an embodiment of the invention which incorporates one or more of these data types will operate as described below, except that attributes of the one or more data types will reflect characteristics of the type of data involved which differentiate different pieces of data instead of characteristics of merchandise. For example, a catalog which contains video might have attributes such as “length” (which might be various ranges of minutes), “type” (which might be “black-and-white” or “color”, or alternatively might include different levels of color quality), or might involve more qualitative attributes such as “genre” (i.e. action, comedy, drama, science-fiction, western) or “rating” (i.e., some sort of scale such as a star system or a points system). Note that some catalogs will have items in the taxonomy which may reflect pieces of merchandise which are linked to “virtual merchandise”, that is pieces of digital media . . . for example, pieces of digital music might be linked to real-world CD albums on which the songs are located. Within the context of these attributes, the embodiments may facilitate the management and access to the media by displaying the attributes in the category pane and using them to facilitate access and to provide information about how the contents of the catalog are associated with various values of the attributes. More information is provided below.

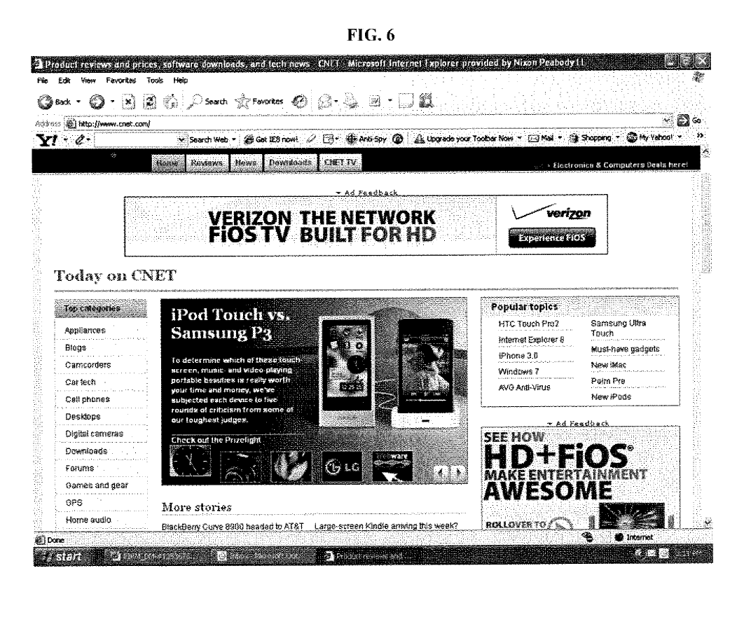

Specifically, the user interface module is ideally designed to provide information about the contents of the catalog via a web page display program, such as a web browser. An example of a catalog that operates in this manner is the CNET™ website, a screenshot of whose homepage is FIG. 6. The CNET™ website demonstrates potential features of an embodiment of the invention, such as that the products may be electronic devices. It also illustrates sample categories for a potential embodiment, such as appliances, camcorders, car tech, cell phones, desktop computers, digital cameras, downloads, forums, games and gear, GPS, home audio, home video, laptops, MP3 players, podcasts, printers, televisions, and videos. Also, as previously discussed, the products may be digital media.

The search engine module 104 may operate as a web page interface that searches the World Wide Web and includes the catalog in its search. This would include commercial search engines such as Google™ and Yahoo™ as well as a propriety search engine module 104 such as the one built into the CNET™ website, or alternative any other commercial or noncommercial search engine or search engine built into a catalog. Alternatively, the search engine module 104 may be one that searches a private network, database, or set of websites.

It is to be noted that the search engine module 104 receives a query from the user. This query will generally be a string of text, such that the query attempts to retrieve keyword search. The keyword search may optionally search for product names, or alternatively search for product descriptions, or both. Alternatively the search may search by product serial number. The search engine module 104 may also use wildcards. The search engine module 104 in the preferred embodiment searches for a single string of text, but there may also be a search based upon an approach such as a search construction page or a graphical search page, so long as the result is a search string that is applied to the search engine module.

Once the search string has been generated, the search string is transferred to the query association module 108 to determine which category or categories it corresponds with. Essentially, the query association module analyzes the query with a two-pass approach, which analyzes the words in the query for their semantic meaning with respect to the categories and attributes of the catalog. This may be accomplished with a lookup table, a decision tree, or any other known association technique that will allow individual words and phrases of adjacent and/or non-adjacent words to correspond with products and organizing principles within the database. Whatever technique is used, it should allow the capability to allow matches that are indicative of but not identical to the names of products or attribute values, so if the user makes a typo the embodiments can adjust. This capability works by trying a series of “near-neighbor” alternatives that differ by replacing characters or adding or subtracting characters. Alternatively, thesauri of synonyms may be used for the association process as well. This process may optionally be interactive and query the user to help obtain the best matches. For example, if a search term was computer, the embodiment might use a dialog box to ask, “Did you mean desktops, or laptops?”

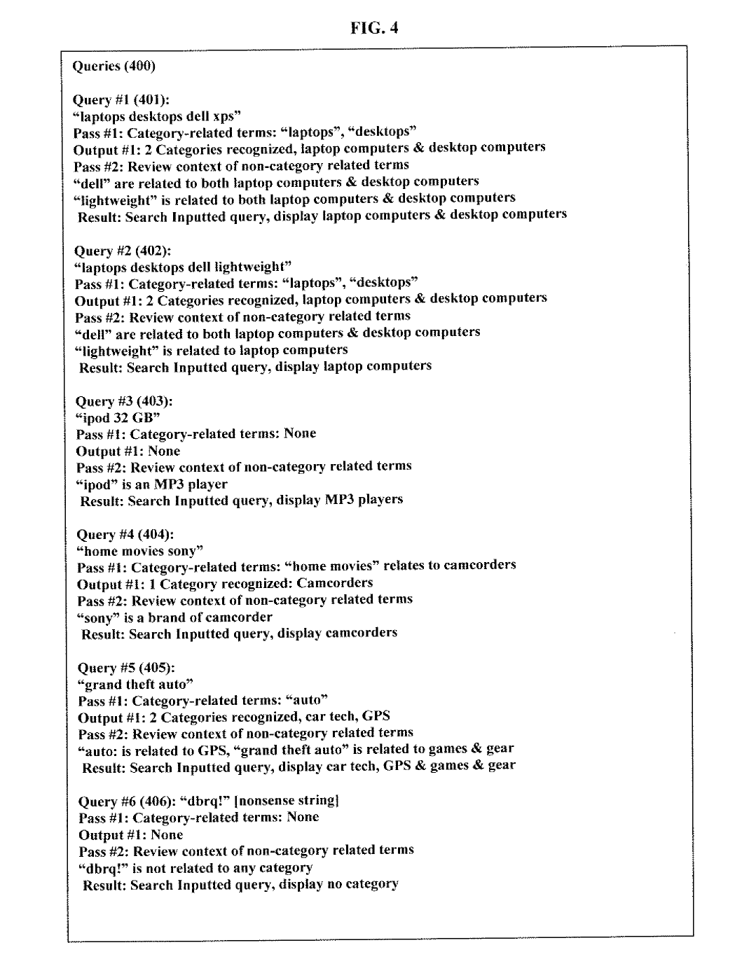

The two pass approach is illustrated with some sample queries within FIG. 4. FIG. 4 gives some examples of searches into the CNET™ catalog and which categories they might be associated with. Pass #1 attempts to identify terms that are specifically category-oriented, so as to be indicative of a category in the ontology of the catalog. Pass two reviews the context of non-category related terms. Six examples from FIG. 4 shall now be considered. It is noted that the user is not necessarily confined to search for products which are relevant to only one category, as is shown by query #1 401, “laptops desktops dell xps”. In this case, the query association module 108 would recognize two categories (because in Pass #2, dell and xps are both keywords that apply to both the laptops and the desktops categories), and instruct the user interface module to split the part of the display devoted to categories between the various categories, or provide a mechanism such as tabs, different windows or a scrollbar to allow the user to switch between categories. Alternatively, the user may be presented with a window so that he or she is able to choose which single category to focus on, and that category is deal with normally. By contrast, in query #2 402, “laptops desktop dell lightweight”, the context-word lightweight suggests that laptops should be preferred as it only makes sense for laptops to be lightweight. Associations like these can be determined by the query association module because it contains an internal knowledge repository which stores associations between various potential search terms and the categories of the catalog. This context-sensitive database may be built manually, or it may automatically be inferred by observing what keywords eventually lead to searches associated with what categories. While this approach is less precise, it may be easier to implement. Thus, some embodiments involve a query association module that discriminates between multiple categories to pick a preferred category based upon the context of the contents of the query to determine which is more relevant, and displays information about the relevant category and information about the query.

In query #3 403, “ipod 32 GB” does not contain any obvious category information for the first pass, but “ipod” may be identified as Apple™'s iPod™ MP3 player, and this provides a category setting. In query #4, 404 “home movies sony”, “home movies” can be analyzed to suggest the category “Camcorders” because camcorders are associated with home movies. In pass #2, “sony” is identified as a brand of camcorder. Thus, camcorders are displayed as the category, and “sony” is searched as the associated brand. In query #5 405, the query “grand theft auto” identifies car tech and GPS on the first pass (due to the term “auto”, which relevant to these categories), but games and gear on the second pass. Finally, in sample query #6 “dbrq!”, a nonsense phrase, neither pass of analysis can recognize a category, so a window which has “No category” would be displayed along with any products that the catalog search engine produces for “dbrq!”.

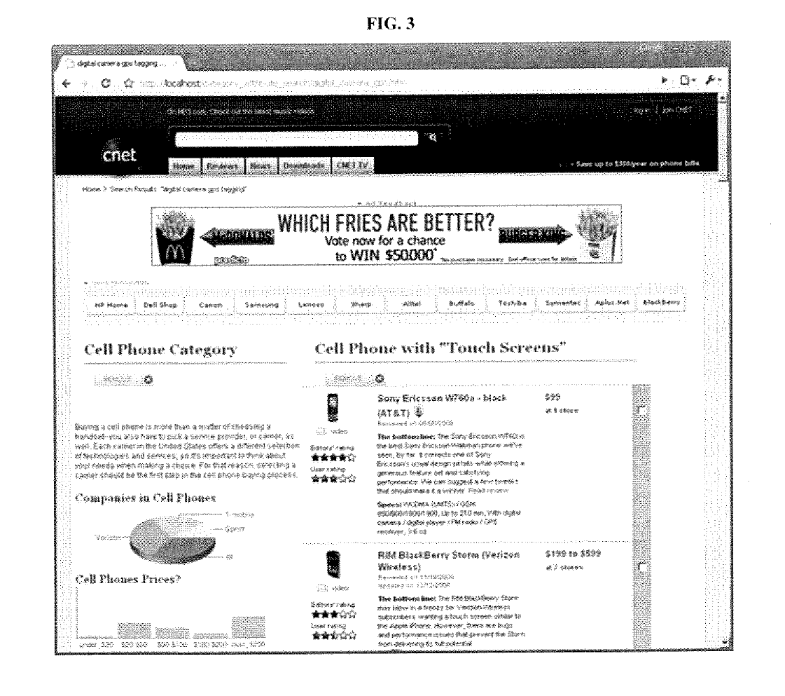

An example of the output one embodiments may produce from a query such as “cell phones touch screens” is provided by FIG. 3. As seen in FIG. 3, the query association module 108 may provide results within two halves of a window. Alternatively, it may provide results within two separate windows. Specifically, the results of a query may be in a window, and the category information is displayed in a pop-up window, or vice-versa. Also as depicted in FIG. 3, the part of the screen that is used to display information about the category or categories may include graphs or other visualizations which summarize information about the category. For example, in FIG. 3, it shows a pie chart showing market share for cell phones and a bar graph for cell phones prices, though any visualization which is a graphical representation of information about the category may be displayed in this situation.

An additional feature which may be present in some embodiments is that the display of category information may include hyperlinks or other controls associated with specific values of attributes which, when selected, update the search display to reflect said attributes which act as filter parameters which narrow the search results, which are then redisplayed to reflect the impact of the control. This gives the user 110 control over the list of items in the catalog by using controls from the categories, facilitating the user's 110 ability to manage and access items in the catalog. An example of how this might work would be that in FIG. 3, the brands in the pie chart might be hyperlinks, and the user could select, for example, Sprint™, and the embodiment would narrow the query so that only cell phones with touch screens whose carrier is Sprint™ would be displayed.

One embodiment of the invention operates as a computer-implemented method designed to use category information from searches to facilitate access to a catalog, illustrated in FIG. The method comprises the steps of, operating, using a processor a database module configured to store an electronic catalog of products, wherein the catalog comprises a taxonomy of products categories and products within the categories, the catalog further comprising attributes which describe products in a category and at least one value for said attributes 501, operating, using a processor, a user interface module configured to display, using a display device, information about the contents of the catalog, in response to input by the user 502, operating, using a processor, a search engine module configured to accept a query from a user, wherein at least part of said query is associated with at least one of the categories, query the catalog, and present a subset of products in the catalog corresponding to the user's query to said user interface module for display to said at least one user 503, operating, using a processor, a query association module configured to monitor the ongoing stream of queries, and analyze the contents of each query to identify if part or all of a query corresponds with a category 504, and when part or all of said query corresponds with a category, said user interface module provides the user with access to the catalog via the user interface module in a manner that includes simultaneous and segregated display of information about the category and information about products which satisfy the query 505.

It should be noted that the catalog access facilitation system 100 is illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a computer-readable medium as above as modules in any manner, and can be used separately or in combination.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

What is claimed is:

1. A computer system designed to use category information from searches to facilitate access to a catalog, comprising:
a database module configured to store an electronic catalog of products, wherein the catalog comprises a taxonomy of products categories and products within the categories, the catalog further comprising attributes which describe products in a category and at least one value for said attributes;
a user interface module configured to display, using a display device, information about the contents of the catalog, in response to input by the user;
a search engine module configured to accept a query from a user, wherein at least part of said query corresponds with at least one of the categories, query the catalog, and present a subset of products in the catalog corresponding to the user's query to said user interface module for display to said at least one user;
a query association module configured to monitor queries, and analyze the contents of each query to identify if part or all of a query corresponds with a category; and
when part or all of said query corresponds with a category, said user interface module provides the user with access to the catalog via the user interface module in a manner that includes simultaneous and segregated display of information about the category and information about products which satisfy the query.

2. The system of claim 1, wherein the categories are electronic devices that include appliances, camcorders, car tech, cell phones, desktop computers, digital cameras, downloads, forums, games and gear, GPS, home audio, home video, laptops, MP3 players, podcasts, printers, televisions, videos.

3. The system of claim 1, wherein said products are digital media.

4. The system of claim 3, wherein said digital media products consist of one or more of digital text, audio, MIDI data, recorded audiobooks, blog entries, digital music, bitmapped and/or vector graphics, digital photographs, video, movies, TV episodes, digital documents, animations, software, web content, multimedia, or encoded or archived data.

5. The system of claim 1, wherein there are one or more top-level categories for the products, and one or more lower-level categories for the products.

6. The system of claim 1, wherein the search engine searches the World Wide Web and includes the catalog in its search.

7. The system of claim 1, wherein the search engine searches a private network and includes the catalog in its search

8. The system of claim 1, wherein the search engine searches for a query that incorporates two or more categories.

9. The system of claim 8, wherein the query association module discriminates between said two or more categories based upon the context of the contents of the query besides the category information to determine which is more relevant, and displays information about the more relevant category and information about the query.

10. The system of claim 1, wherein the search engine uses a keyword search.

11. The system of claim 10, wherein the keyword search searches product names.

12. The system of claim 11, wherein the keyword search searches product descriptions.

13. The system of claim 11, wherein the search engine uses wildcards.

14. The system of claim 1, wherein the search engine searches by product serial number.

15. The system of claim 1, wherein the query association module provides results within two halves of a window.

16. The system of claim 1, wherein the query association module provides results within two separate windows.

17. The system of claim 1, wherein the query association module provides results such that the results of the query are displayed in a window and the category information is displayed in a pop-up window.

18. The system of claim 1, wherein the query association module provides results such that the category information is displayed in a window and the results of the query are displayed in a pop-up window.

19. The system of claim 1, wherein the category information is displayed as including one or more graphs or other visualizations which summarize information about the category.

20. The system of claim 1, where the display of category information includes hyperlinks or other controls associated with specific values of attributes which, when selected, update the search display to reflect said attributes which act as filter parameters which narrow the search results, which are then redisplayed.

21. A computer-implemented method designed to use category information from searches to facilitate access to a catalog, comprising:
operating, using a processor, a database module configured to store an electronic catalog of products, wherein the catalog comprises a taxonomy of products categories and products within the categories, the catalog further comprising attributes which describe products in a category and at least one value for said attributes;
operating, using a processor, a user interface module configured to display, using a display device, information about the contents of the catalog, in response to input by the user;
operating, using a processor, a search engine module configured to accept a query from a user, wherein at least part of said query corresponds with at least one of the categories, query the catalog, and present a subset of products in the catalog corresponding to the user's query to said user interface module for display to said at least one user;
operating, using a processor, a query association module configured to monitor queries, and analyze the contents of each query to identify if part or all of a query corresponds with a category; and
when part or all of said query corresponds with a category, said user interface module provides the user with access to the catalog via the user interface module in a manner that includes simultaneous and segregated display of information about the category and information about products which satisfy the query.

22. The method of claim 21, wherein the categories are electronic devices that include appliances, camcorders, car tech, cell phones, desktop computers, digital cameras, downloads, forums, games and gear, GPS, home audio, home video, laptops, MP3 players, podcasts, printers, televisions, videos.

23. The method of claim 21, wherein said products are digital media.

24. The method of claim 23, wherein said digital media products consist of one or more of digital text, audio, MIDI data, recorded audiobooks, blog entries, digital music, bitmapped and/or vector graphics, digital photographs, video, movies, TV episodes, digital documents, animations, software, web content, multimedia, or encoded or archived data.

25. The method of claim 21, wherein there are one or more top-level categories for the products, and one or more lower-level categories for the products.

26. The method of claim 21, wherein the search engine searches the World Wide Web and includes the catalog in its search.

27. The method of claim 21, wherein the search engine searches a private network and includes the catalog in its search

28. The method of claim 21, wherein the search engine searches for a query that incorporates two or more categories.

29. The method of claim 28, wherein the query association module discriminates between said two or more categories based upon the context of the contents of the query besides the category information to determine which is more relevant, and displays information about the more relevant category and information about the query.

30. The method of claim 21, wherein the search engine uses a keyword search.

31. The method of claim 30, wherein the keyword search searches product names.

32. The method of claim 30, wherein the keyword search searches product descriptions.

33. The method of claim 30, wherein the search engine uses wildcards.

34. The method of claim 31, wherein the search engine searches by product serial number.

35. The method of claim 21, wherein the query association module provides results within two halves of a window.

36. The method of claim 21, wherein the query association module provides results within two separate windows.

37. The method of claim 21, wherein the query association module provides results such that the results of the query are displayed in a window and the category information is displayed in a pop-up window.

38. The method of claim 21, wherein the query association module provides results such that the category information is displayed in a window and the results of the query are displayed in a pop-up window.

39. The method of claim 21, wherein the category information is displayed as including one or more graphs or other visualizations which summarize information about the category.

40. The method of claim 21, where the display of category information includes hyperlinks or other controls associated with specific values of attributes which, when selected, update the search display to reflect said attributes which act as filter parameters which narrow the search results, which are then redisplayed.

41. An apparatus designed to use category information from searches to facilitate access to a catalog, comprising:
means for operating, using a processor, a database module configured to store an electronic catalog of products, wherein the catalog comprises a taxonomy of products categories and products within the categories, the catalog further comprising attributes which describe products in a category and at least one value for said attributes;
means for operating, using a processor, a user interface module configured to display, using a display device, information about the contents of the catalog, in response to input by the user;
means for operating, using a processor, a search engine module configured to accept a query from a user, wherein at least part of said query corresponds with at least one of the categories, query the catalog, and present a subset of products in the catalog corresponding to the user's query to said user interface module for display to said at least one user;
means for operating, using a processor, a query association module configured to monitor queries, and analyze the contents of each query to identify if part or all of a query corresponds with a category; and
when part or all of said query corresponds with a category, said user interface module provides the user with access to the catalog via the user interface module in a manner that includes simultaneous and segregated display of information about the category and information about products which satisfy the query.

42. The apparatus of claim 41, wherein the categories are electronic devices that include appliances, camcorders, car tech, cell phones, desktop computers, digital cameras, downloads, forums, games and gear, GPS, home audio, home video, laptops, MP3 players, podcasts, printers, televisions, videos.

43. The apparatus of claim 41, wherein said products are digital media.

44. The apparatus of claim 43, wherein said digital media products consist of one or more of digital text, audio, MIDI data, recorded audiobooks, blog entries, digital music, bitmapped and/or vector graphics, digital photographs, video, movies, TV episodes, digital documents, animations, software, web content, multimedia, or encoded or archived data.

45. The apparatus of claim 41, wherein there are one or more top-level categories for the products, and one or more lower-level categories for the products.

46. The apparatus of claim 41, wherein the search engine searches the World Wide Web and includes the catalog in its search.

47. The apparatus of claim 41, wherein the search engine searches a private network and includes the catalog in its search

48. The apparatus of claim 41, wherein the search engine searches for a query that incorporates two or more categories.

49. The apparatus of claim 48, wherein the query association module discriminates between said two or more categories based upon the context of the contents of the query besides the category information to determine which is more relevant, and displays information about the more relevant category and information about the query.

50. The apparatus of claim 41, wherein the search engine uses a keyword search.

51. The apparatus of claim 50, wherein the keyword search searches product names.

52. The apparatus of claim 50, wherein the keyword search searches product descriptions.

53. The apparatus of claim 50, wherein the search engine uses wildcards.

54. The apparatus of claim 51, wherein the search engine searches by product serial number.

55. The apparatus of claim 41, wherein the query association module provides results within two halves of a window.

56. The apparatus of claim 41, wherein the query association module provides results within two separate windows.

57. The apparatus of claim 41, wherein the query association module provides results such that the results of the query are displayed in a window and the category information is displayed in a pop-up window.

58. The apparatus of claim 41, wherein the query association module provides results such that the category information is displayed in a window and the results of the query are displayed in a pop-up window.

59. The apparatus of claim 41, wherein the category information is displayed as including one or more graphs or other visualizations which summarize information about the category.

60. The apparatus of claim 41, where the display of category information includes hyperlinks or other controls associated with specific values of attributes which, when selected, update the search display to reflect said attributes which act as filter parameters which narrow the search results, which are then redisplayed.

61. Computer readable media, having instructions stored thereon, wherein the instructions, when executed by a processor, perform computing functions designed to use category information from searches to facilitate access to a catalog stored on a computer, comprising:
instructions for operating, using a processor, a database module configured to store an electronic catalog of products, wherein the catalog comprises a taxonomy of products categories and products within the categories, the catalog further comprising attributes which describe products in a category and at least one value for said attributes;
instructions for operating, using a processor, a user interface module configured to display, using a display device, information about the contents of the catalog, in response to input by the user;
instructions for operating, using a processor, a search engine module configured to accept a query from a user, wherein at least part of said query corresponds with at least one of the categories, query the catalog, and present a subset of products in the catalog corresponding to the user's query to said user interface module for display to said at least one user;
instructions for operating, using a processor, a query association module configured to monitor queries, and analyze the contents of each query to identify if part or all of a query corresponds with a category; and
when part or all of said query corresponds with a category, said user interface module provides the user with access to the catalog via the user interface module in a manner that includes simultaneous and segregated display of information about the category and information about products which satisfy the query.

62. The computer readable media of claim 61, wherein the categories are electronic devices that include appliances, camcorders, car tech, cell phones, desktop computers, digital cameras, downloads, forums, games and gear, GPS, home audio, home video, laptops, MP3 players, podcasts, printers, televisions, videos.

63. The computer readable media of claim 61, wherein said products are digital media.

64. The computer readable media of claim 63, wherein said digital media products consist of one or more of digital text, audio, MIDI data, recorded audiobooks, blog entries, digital music, bitmapped and/or vector graphics, digital photographs, video, movies, TV episodes, digital documents, animations, software, web content, multimedia, or encoded or archived data.

65. The computer readable media of claim 61, wherein there are one or more top-level categories for the products, and one or more lower-level categories for the products.

66. The computer readable media of claim 61, wherein the search engine searches the World Wide Web and includes the catalog in its search.

67. The computer readable media of claim 61, wherein the search engine searches a private network and includes the catalog in its search

68. The computer readable media of claim 61, wherein the search engine searches for a query that incorporates two or more categories.

69. The computer readable media of claim 68, wherein the query association module discriminates between said two or more categories based upon the context of the contents of the query besides the category information to determine which is more relevant, and displays information about the more relevant category and information about the query.

70. The computer readable media of claim 61, wherein the search engine uses a keyword search.

71. The computer readable media of claim 70, wherein the keyword search searches product names.

72. The computer readable media of claim 70, wherein the keyword search searches product descriptions.

73. The computer readable media of claim 70, wherein the search engine uses wildcards.

74. The computer readable media of claim 71, wherein the search engine searches by product serial number.

75. The computer readable media of claim 61, wherein the query association module provides results within two halves of a window.

76. The computer readable media of claim 61, wherein the query association module provides results within two separate windows.

77. The computer readable media of claim 61, wherein the query association module provides results such that the results of the query are displayed in a window and the category information is displayed in a pop-up window.

78. The computer readable media of claim 61, wherein the query association module provides results such that the category information is displayed in a window and the results of the query are displayed in a pop-up window.

79. The computer readable media of claim 61, wherein the category information is displayed as including one or more graphs or other visualizations which summarize information about the category.

80. The computer readable media of claim 61, where the display of category information includes hyperlinks or other controls associated with specific values of attributes which, when selected, update the search display to reflect said attributes which act as filter parameters which narrow the search results, which are then redisplayed.
